(19) United States
(12) Patent Application Publication
(10) Pub. No.: US 2023/0121673 A1
(43) Pub. Date: Apr. 20, 2023

(54) Information Processing Method and Apparatus, Computing Device, Medium, and Computer Program

(71) Applicant: Siemens Aktiengesellschaft, München (DE)

(72) Inventors: Xing Xing He, Beijing (CN); Qi Wang, Wuhan (CN); Li Wang, Beijing (CN)

(73) Assignee: Siemens Aktiengesellschaft, München (DE)

(21) Appl. No.: 17/914,643

(22) PCT Filed: Mar. 31, 2020
(86) PCT No.: PCT/CN2020/082458

§ 371 Date: Sep. 26, 2022

(51) Int. Cl. G06F 8/35; G16Y 10/75

(52) U.S. Cl. CPC G06F 8/35; G16Y 10/75

(57) ABSTRACT

The disclosure relates to an information processing method and apparatus, a computing device, a medium, and a computer program. In some embodiments, the information processing method includes: defining an IOT semantic model file of a specific object using an existing IOT semantic model; generating an OPC UA information model based on the IOT semantic model file; parsing the OPC UA information model into an OPC UA protocol-compliant file; and generating a source code available for an OPC UA protocol stack using an adapter based on the OPC UA protocol-compliant file.

### CROSS REFERENCE TO RELATED APPLICATIONS

This application is a U.S. National Stage Application of International Application No. PCT/CN2020/082458 filed Mar. 31, 2020, which designates the United States of America, the contents of which are hereby incorporated by reference in their entirety.

### TECHNICAL FIELD

The disclosure generally relates to the technical field of the Internet of Things. Some embodiments of the teachings herein include information processing methods and/or apparatus.

### BACKGROUND

An Open Platform Communication Unified Architecture (OPC UA) protocol is widely used in the industrial field. An OPC UA information model defines a comprehensive data model for a physical device, including objects, data, services, and modes how they are related to each other. Although the OPC UA provides a basic metadata model, it is still difficult to define a complex system because multiple types of information and additional structure-based reference types are required. In addition, object-oriented and distributed system knowledge is also required.

Currently, in order to create an OPC UA information model, it is necessary to draw pictures using tools to implement the OPC UA information model. Currently, there are two commonly used tools: an OPC UA modeler and a UA-model compiler.

1. The OPC UA modeler may provide a graphic design of an address space, and may represent the hierarchical and graphic representation of a design model. However, the OPC UA modeler requires not only the relevant knowledge of a device model, but also object-oriented design knowledge, so the modeler is not easy to use. In addition, when modifying a top node, users need to manually modify all child nodes.

2. The UA-model compiler is provided by an OPC UA foundation. In order to use the UA-model compiler, users need to manually write an information model according to an architecture design file, and then use the UA-model compiler to generate a code for an OPC UA protocol stack. Apparently, a large amount of work is required to manually write information models for multiple different devices.

### SUMMARY

A brief overview of the disclosure is given below in order to provide a basic understanding of certain aspects of the disclosure. It should be understood that this summary is not an exhaustive overview of the disclosure. It is not intended to determine key or important parts of the disclosure, nor is it intended to limit the scope of the disclosure. The purpose is merely to present some concepts in a simplified form as a prelude to the more detailed description that is discussed later. For example, some embodiments include an information processing method comprising: defining an IOT semantic model file of a specific object using an existing IOT semantic model; generating an OPC UA information model based on the IOT semantic model file; parsing the OPC UA information model into an OPC UA protocol-compliant file; and generating a source code available for an OPC UA protocol stack using an adapter based on the OPC UA protocol-compliant file.

In some embodiments, generating an OPC UA information model based on the IOT semantic model file comprises: semantically analyzing the IOT semantic model file to obtain a UML file; converting the UML file into an OPC UA protocol-compliant UML view model using an existing OPC UA metadata model; and parsing the UML view model into corresponding nodes so as to generate an OPC UA information model.

In some embodiments, the UML view model is subjected to text editing and relationship adjustment by a user.

In some embodiments, defining an IOT semantic model file of a specific object using an existing IOT semantic model comprises: converting the IOT semantic model file into a JSON format.

In some embodiments, the OPC UA protocol-compliant file comprises at least one of an XML file, a bsd file, and a document file.

In some embodiments, he specific object comprises at least one of a physical device and a virtual entity.

As another example, some embodiments include an information processing apparatus comprising: an IOT semantic model file defining unit, configured to define an IOT semantic model file of a specific object using an existing IOT semantic model; an OPC UA information model generating unit, configured to generate an OPC UA information model based on the IOT semantic model file; a parsing unit, configured to parse the OPC UA information model into an OPC UA protocol-compliant file; and a source code generating unit, configured to generate a source code available for an OPC UA protocol stack using an adapter based on the OPC UA protocol-compliant file.

In some embodiments, the OPC UA information model generating unit comprises: a semantic analysis subunit, configured to semantically analyze the IOT semantic model file to obtain a UML file; a view model generating subunit, configured to convert the UML file into an OPC UA protocol-compliant UML view model using an existing OPC UA metadata model; and an information model generating subunit, configured to parse the UML view model into corresponding nodes so as to generate an OPC UA information model.

In some embodiments, the view model generating subunit is further configured to perform text editing and relationship adjustment by a user.

In some embodiments, the IOT semantic model file defining unit is further configured to convert the IOT semantic model file into a JSON format.

In some embodiments, the OPC UA protocol-compliant file comprises at least one of an XML file, a bsd file, and a document file.

In some embodiments, the specific object comprises at least one of a physical device and a virtual entity.

As another example, some embodiments include a computing device (600) comprising: at least one processor (602); and a memory (604) coupled to the at least one processor (602), the memory being configured to store instructions that, when executed by the at least one processor (602), cause the processor (602) to perform one or more of the methods described herein.

As another example, some embodiments include a non-transitory machine-readable storage medium storing executable instructions that, when executed, cause a machine to perform one or more of the methods described herein.

As another example, some embodiments include a computer program comprising computer-executable instructions that, when executed, cause at least one processor to perform one or more of the methods described herein.

As another example, some embodiments include a computer program product tangibly stored on a computer-readable medium and comprising computer-executable instructions that, when executed, cause at least one processor to perform one or more of the methods described herein.

### BRIEF DESCRIPTION OF THE DRAWINGS

Referring to the descriptions of the example embodiments of the teachings of the present disclosure in combination with the accompanying drawings, the foregoing and other objectives, features, and advantages of the teachings herein may be more easily understood. Components in the accompanying drawings are merely used for demonstrating principles of the present disclosure. In the accompanying drawings, the same or similar technical features or components may be represented by using the same or similar reference numerals.

FIG. 1 is a flowchart illustrating an exemplary process of an information processing method incorporating teachings of the present disclosure;

FIG. 2 is a flowchart illustrating an exemplary process of step S104 in FIG. 1;

FIG. 3 is a schematic diagram of a UML view model incorporating teachings of the present disclosure;

FIG. 4 is a block diagram illustrating an exemplary configuration of an information processing apparatus incorporating teachings of the present disclosure;

FIG. 5 is a block diagram showing an exemplary configuration of an OPC UA information model generation unit in FIG. 4; and

FIG. 6 illustrates a block diagram of a computing device 600 of an information processing method incorporating teachings of the present disclosure.

Drawing reference numerals

| | |
|---|---|
| 100: Information processing method | S102, S104, S1042, S1044, S1046, S106, S108: Step |
| 300: UML view model | 400: Information processing apparatus |
| 402: IOT semantic model file defining unit | 404: OPC UA information model generating unit |
| 406: Parsing unit | 408: Source code generating unit |
| 4042: Semantic analysis subunit | 4044: View model generating subunit |
| 4046: Information model generating subunit | 600: Computing device |
| 602: Processor | 604: Memory |

### DETAILED DESCRIPTION

Some embodiments of the teachings herein may include a method for generating and exporting an OPC UA information model based on an IOT semantic model, which uses an existing IOT semantic model, may be easily organized, and may be flexibly modified and upgraded independent of an OPC UA source code.

In some embodiments, an information processing method includes: defining an IOT semantic model file of a specific object using an existing IOT semantic model; generating an OPC UA information model based on the IOT semantic model file; parsing the OPC UA information model into an OPC UA protocol-compliant file; and generating a source code available for an OPC UA protocol stack using an adapter based on the OPC UA protocol-compliant file.

In some embodiments, generating an OPC UA information model based on the IOT semantic model file includes: semantically analyzing the IOT semantic model file to obtain a UML file; converting the UML file into an OPC UA protocol-compliant UML view model using an existing OPC UA metadata model; and parsing the UML view model into corresponding nodes so as to generate an OPC UA information model.

In some embodiments, the UML view model is subjected to text editing and relationship adjustment by a user.

In some embodiments, defining an IOT semantic model file of a specific object using an existing IOT semantic model includes converting the IOT semantic model file into a JSON format.

In some embodiments, the OPC UA protocol-compliant file includes at least one of an XML file, a bsd file, and a document file.

In some embodiments, the specific object includes at least one of a physical device and a virtual entity.

In some embodiments, an information processing apparatus includes: an IOT semantic model file defining unit, configured to define an IOT semantic model file of a specific object using an existing IOT semantic model; an OPC UA information model generating unit, configured to generate an OPC UA information model based on the IOT semantic model file; a parsing unit, configured to parse the OPC UA information model into an OPC UA protocol-compliant file; and a source code generating unit, configured to generate a source code available for an OPC UA protocol stack using an adapter based on the OPC UA protocol-compliant file.

In some embodiments, the OPC UA information model generating unit includes: a semantic analysis subunit, configured to semantically analyze the IOT semantic model file to obtain a UML file; a view model generating subunit, configured to convert the UML file into an OPC UA protocol-compliant UML view model using an existing OPC UA metadata model; and an information model generating subunit, configured to parse the UML view model into corresponding nodes so as to generate an OPC UA information model.

In some embodiments, the view model generating subunit is further configured to perform text editing and relationship adjustment by a user.

In some embodiments, the IOT semantic model file defining unit is further configured to convert the IOT semantic model file into a JSON format.

In some embodiments, the OPC UA protocol-compliant file includes at least one of an XML file, a bsd file, and a document file.

In some embodiments, the specific object includes at least one of a physical device and a virtual entity.

In some embodiments, a computing device includes: at least one processor; and a memory coupled to the at least one processor. The memory is configured to store instructions that, when executed by the at least one processor, cause the processor to perform the method as described above.

In some embodiments, a non-transitory machine-readable storage medium stores executable instructions that, when executed, cause a machine to perform one or more of the methods as described herein.

In some embodiments, a computer program includes computer-executable instructions that, when executed, cause at least one processor to perform one or more of the methods as described herein.

In some embodiments, a computer program product is tangibly stored on a computer-readable medium and includes computer-executable instructions that, when executed, cause at least one processor to perform one or more of the methods as described herein.

In some embodiments, an existing IOT semantic model is used to reduce the complexity of an information model. Then, it is easy to maintain because a semantic model that is friendly to people reading is used. Finally, a mode of exporting an information model at runtime is provided, which means that users may easily upgrade the information model based on system changes. In some embodiments, a semantic model, semantic analysis, and a distributed object technology may be combined for friendly and flexible use.

It should be understood that, discussions of these implementations are merely intended to make a person skilled in the art better understand and implement the subject described in this specification, and is not intended to limit the protection scope of the claims, the applicability, or examples. Changes may be made to the functions and arrangements of the discussed elements without departing from the protection scope of the content of the disclosure. Various processes or components may be omitted, replaced, or added in each example according to requirements. For example, the described method may be performed according to a sequence different from the sequence described herein, and steps may be added, omitted or combined. In addition, features described in some examples may also be combined in other examples.

As used in this specification, the term “include” and variants thereof represent open terms, and means “include but is not limited to”. The term “based on” represents “at least partially based on”. The terms “one embodiment” and “an embodiment” represent “at least one embodiment”. The term “another embodiment” represents “at least one another embodiment”. The terms “first”, “second” and the like may represent different objects or the same object. Other definitions may be included explicitly or implicitly. Unless otherwise clearly specified, the definition of one term is consistent in the entire specification.

In some embodiments, a method for generating and exporting an OPC UA information model based on an IOT semantic model uses an existing IOT semantic model, may be easily organized, and may be flexibly modified and upgraded independent of an OPC UA source code. In some embodiments, an existing IOT semantic model is used as an input file, and a source code available for an OPC UA protocol stack is finally generated. The code is independent of a source code of an OPC unified architecture.

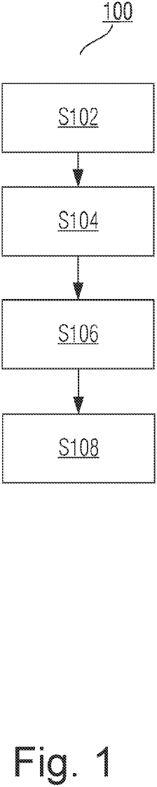

FIG. 1 is a flowchart illustrating an exemplary process of an information processing method 100 according to one embodiment of the disclosure.

In step S102, an IOT semantic model file of a specific object is defined using an existing IOT semantic model. The specific object may be a physical device, such as a sensor, or may be a virtual entity, such as a service. Currently, a large number of IOT semantic models are published, such as Thing Description or an Ali IOT model. The following briefly introduces the two semantic models. Thing Description describes metadata and interfaces of Thing according to a W3C Web of Thing (WoT) standard. Thing is an abstraction of a physical or virtual entity that provides an interface to Web of Thing and participates therein.

The Ali IOT model describes the functionality of Thing from three perspectives: operating status properties of a device, services supported by a device, and events that may be published and subscribed among a device, a gateway, and a cloud.

In some embodiments, the existing IOT semantic models may be used to define an IOT semantic model file of a specific object. There is no limitation on which IOT semantic model is used. In some embodiments, the detection of fire or gas leakage is taken as a specific example to illustrate a specific process of generating an OPC UA code stack using the method according to the disclosure.

In order to monitor fire or gas leakage, users may install three sensors: a smoke sensor, a carbon monoxide sensor, and a temperature sensor. Firstly, an IOT semantic model file is defined for each sensor. In one example, the IOT semantic model file of each sensor is defined according to the Thing Description (TD) of a W3C Web of Things (WoT) standard.

The following are the IOT semantic model files of the three sensors.

{ { {
“name”: “Smoke “name”: ”Carbon “name”:
Sensor“, monoxide Sensor“, “Temperature
“id”: 10001, “id”: 1002, Sensor”,
“outputData”: { “outputData”: { “id”: 1003,
“type”: “type”:
“Float”, “Float”, “outputData”: {
“unit”: “V”, “unit”: “V”, “type”:
“minimum”: “minimum”: “Integer”
0.1, 0.6, “unit”: ”
“maximum”: 4 “maximum”: 3 °C”,
}, },
“detect range”: { “detect range”: { “minimum”: -55,
“type”: “type”:
“Integer”, “Integer”, “maximum”: +125
“unit”: “unit”: }
“ppm”, “ppm”, }
“minimum”: “minimum”: 1,
300, “maximum”:
“maximum”: 1000 Temperature sensor
1000 },
}, “response time”: {
“response time”: “type”:
{ “Integer”,
“type”: “unit”:
“Integer”, “second”,
“unit”: “maximum”: 20
“second”, },
“maximum”: 20 “Environment
}, temperature”: {
“Environment “type”:
temperature”: { “Integer”,
“type”: “unit”: “°C”,
“Integer”, “minimum”:
20,
“unit”: “°C”, “maximum”: 25
“minimum”: }
18, }
“maximum”: 22 Carbon monoxide
} sensor
}
Smoke sensor

It can be understood that other existing IOT semantic models may also be used to define an IOT semantic model file of a sensor. The descriptions thereof are omitted herein.

In some embodiments, after the IOT semantic model file of the sensor is defined, a sensor template provided by WoT may be used to convert the IOT semantic model file into a JSON format file. For example, the following code shows code snippet JSON files of the smoke sensor and the temperature sensor.

[ {
{ “@type”: [
“@type”: [ “Property”,
“Property”, “SmokeSensor”
“TemperatureSensor” ],
], “name”: “Smoke Sensor
“name”: “Temperature 1”,
Sensor 1”, “id”: “1001”,
“id”: “1003”, “parmCtx”: [{
“parmCtx”: [{ “description”:
“description”: “voltage param”,
“temperature param”, “type”: “float”,
“type”: “integer”, “unit”: “V”,
“unit”: “degree “minimum”: “0.1”,
centigrade”, “maximum”: “4”,
“minimum”: “-55”, “name”:
“maximum”: “125”, “currentValue”,
“name”: “function”:
“currentValue”, “getCurrentValue”
“function”: }, {
“getCurrentValue” “description”:
}] “temperature param”,
}, “type”: “integer”,
“unit”: “ppm”,
Temperature sensor “minimum”: “300”,
“maximum”: “1000”,
“name”:
“currentValue”,
“function”:
“getCurrentValue”
} ]
...
} ]
Smoke sensor

After an IOT semantic model file is defined, in step S104, an OPC UA information model is generated based on the IOT semantic model file. Generally, the IOT semantic model includes general metadata about devices and representation functions, but the IOT semantic model lacks a connection relationship in a system. Therefore, in the method of the disclosure, a wrapper is applied to the IOT semantic model, and a reference between semantic models is added to construct a system hierarchy, thereby outputting an information model of an object-oriented structure.

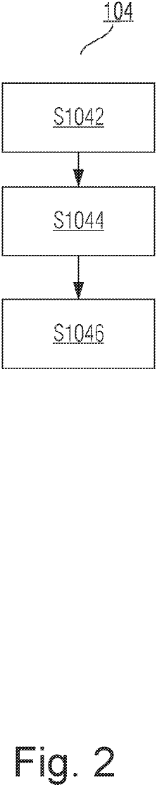

FIG. 2 is a flowchart illustrating an exemplary process of step S104 in FIG. 1. As shown in FIG. 2, in step S1042, the IOT semantic model file is semantically analyzed to obtain a UML file. The IOT semantic model file output in step S102 may be subjected to simple semantic analysis by word-by-word comparison. A complex IOT semantic model file may be semantically analyzed based on a neural network. Those skilled in the art may understand a specific process of semantically analyzing the IOT semantic model file. The descriptions thereof are omitted herein.

In the above example, it can be found that the smoke sensor and the carbon monoxide sensor have similar structures, and both need to use a temperature value as a reference. By semantically analyzing the respective semantic model files of the smoke sensor and the carbon monoxide sensor, UML files of the smoke sensor and the carbon monoxide sensor as shown below may be obtained.

[image]

In one example, UML files may pop up in a user interface for user interaction. Users may edit text according to their needs.

In step S1044, an OPC UA protocol-compliant UML view model is generated from the UML file using an existing OPC UA metadata model.

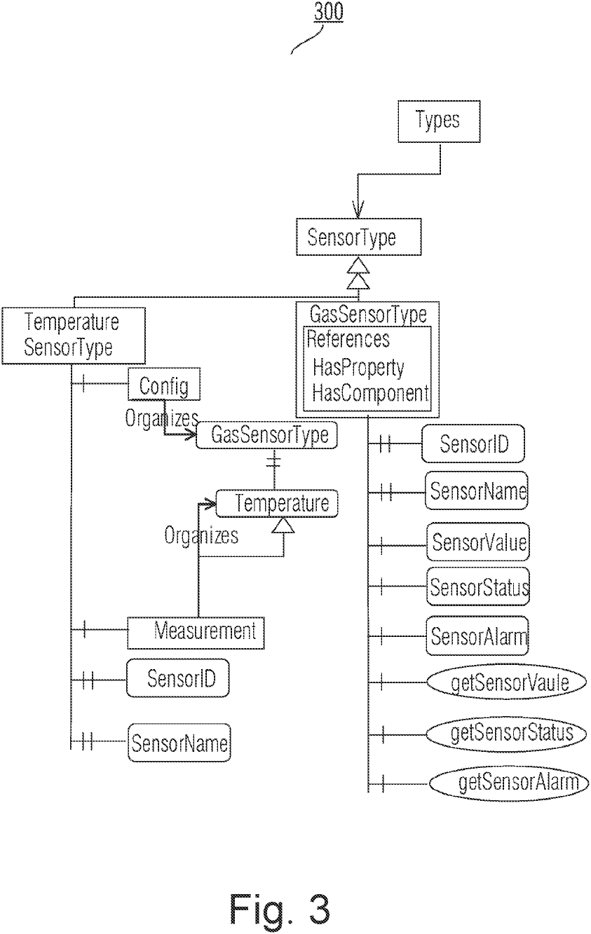

FIG. 3 is a schematic diagram of a UML view model generated based on the above UML file. In FIG. 3, a symbol [symbol] indicates HasEventsource, a symbol [symbol] indicates HasComponenet, a symbol [symbol] indicates HasProperty, and a symbol [symbol] indicates HasSubtype.

As shown in FIG. 3, GasSensorType and TemperatureSensorType may be generated as a subset of BasicObjectType. TemperatureSensorType includes a temperature property, which is also organized as an additional property of GasSensorType. Users may edit text, adjust relationships, etc. for UML view models, and then confirm a final UML view model. FIG. 3 is only a schematic diagram of a specific example of a UML view model. The descriptions are omitted herein.

Finally, in step S1046, the UML view model is parsed into corresponding nodes so as to generate an OPC UA information model. Before parsing the UML view model, users may find some common models from the OPC UA foundation, such as PLC, Profinet, and Robot, to load a model file to text the UML view model in a format defined by a model file.

In the above example, users write the model file in a format defined in an OPC UA model design document. The following code is an example of a template for the model file.

<?xml version=“1.0” encoding=“utf-8”?>
<ModelDesign
xmlns:uax=“http://opcfoundation.org/UA/2008/02/Types.xsd”
xmlns:xsi=“http://www.w3.org/2001/XMLSchema-instance”
xmlns:ua=“http://opcfoundation.org/UA/”
xmlns:ANIMAL=“https://OPC UA.iotexample/UA/senor/”
xmlns:xsd=“http://www.w3.org/2001/XMLSchema”
TargetNamespace=“https://OPC UA.iotexample/UA/senor/”
TargetXmlNamespace=“https://OPC
UA.iotexample/UA/senor/”
TargetVersion=“0.9.0”
TargetPublicationDate=“2020-02-01T00:00:00Z”
xmlns=“http://opcfoundation.org/UA/ModelDesign.xsd”>
<Namespaces>
<Namespace Name=“sensor” Prefix=“sensor”
XmlNamespace=“https://OPC UA.iotexample/UA/sesnsor/Types.xsd”
XmlPrefix=“sensor”>
https://OPC UA.iotexample/UA/senor/</Namespace>
<Namespace Name=“OPC UA”
Version=“1.03”PublicationDate=“2013-12-02T00:00:00Z”
Prefix=“Opc.Ua”InternalPrefix=“Opc.Ua.Server”
XmlNamespace=“http://opcfoundation.org/UA/2008/02/Types.xsd”XmlPr
efix=“OPC UA”>http://opcfoundation.org/UA/</Namespace>
</Namespaces>
<!-- ### Reference Types ###-->
<!-- ### Object Types ###-->
<!-- ### Variable Types ###-->
<!-- ### Data Types ###-->
<!-- ### Objects ###-->
</ModelDesign>

After loading the model file, the UML view model is parsed into multiple nodes. For example, the following code represents a node “ObjectType”, and then an OPC UA information model may be generated based on the multiple nodes.

<!-- ### Object Types ###-->
<!--SensorType with mandatory name -->
<ObjectTypeSymbolicName=“SENSOR:sensorType”
BaseType=“ua:BaseObjectType” IsAbstract=“true”
SupportsEvents=“true”>
<Description>Base type for all sensors</Description>
<Children>
<Property SymbolicName=“Sensor:Name”
DataType=“ua:String” ValueRank=“Scalar”
ModellingRule=“Mandatory”>
<Description>Name of the sensor</Description>
</Property>
</Children>
</ObjectType>

With reference to the operation of step S104 described in FIG. 2, an OPC UA information model may be generated based on the IOT semantic model file. Next, in step S106, the OPC UA information model is parsed into an OPC UA protocol-compliant file. The OPC UA information model may be parsed using a parser integrated in an OPC UA tool (for example, a UA-ModelCompiler). The generated OPC UA protocol-compliant file may include an XML file of a standard format (for example, NodeSet.xml). Optionally, a bsd file for generating data types, a document file for browsing, and other required files may also be included.

Finally, in step S108, a source code available for an OPC UA protocol stack is generated using an adapter based on the OPC UA protocol-compliant file. By means of this step, a source code to be used in a programming language-based OPC UASDK may be generated. open62541 is taken as an example. This is an OPC unified architecture implemented by an open source C language. A generated header file may be used, and a function may be called to construct an object of a defined type to use the generated source code. Those skilled in the art may use some existing tools to generate a source code available for an OPC UA protocol stack. The descriptions are omitted herein.

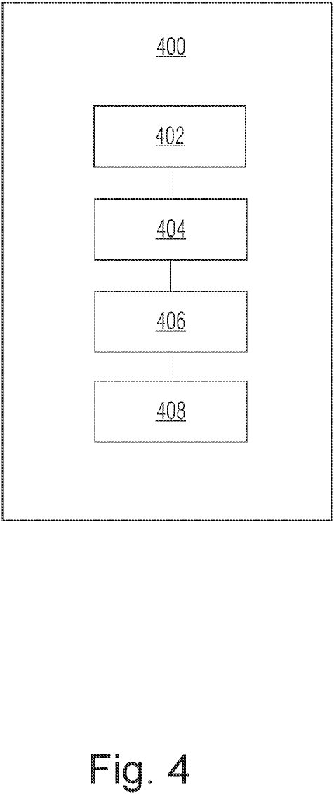

FIG. 4 is a block diagram illustrating an exemplary configuration of an information processing apparatus 400 according to one embodiment of the disclosure. As shown in FIG. 4, the information processing apparatus 400 includes: an IOT semantic model file defining unit 402, an OPC UA information model generating unit 404, a parsing unit 406, and a source code generating unit 408.

The IOT semantic model file defining unit 402 is configured to define an IOT semantic model file of a specific object using an existing IOT semantic model. The OPC UA information model generating unit 404 is configured to generate an OPC UA information model based on the IOT semantic model file. The parsing unit 406 is configured to parse the OPC UA information model into an OPC UA protocol-compliant file. The source code generating unit 408 is configured to generate a source code available for an OPC UA protocol stack using an adapter based on the OPC UA protocol-compliant file.

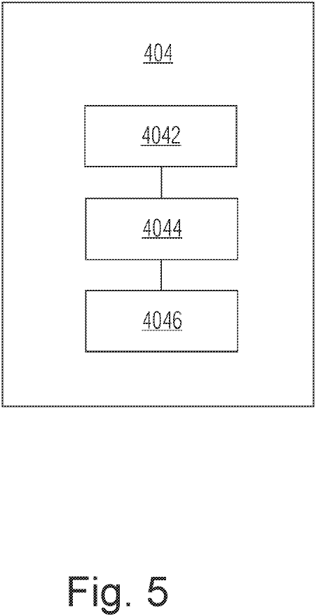

FIG. 5 is a block diagram showing an exemplary configuration of an OPC UA information model generation unit 404 in FIG. 4. As shown in FIG. 5, the OPC UA information model generation unit 404 includes: a semantic analysis subunit 4042, a view model generating subunit 4044, and an information model generating subunit 4046.

The semantic analysis subunit 4042 is configured to semantically analyze the IOT semantic model file to obtain a UML file. The view model generating subunit 4044 is configured to convert the UML file into an OPC UA protocol-compliant UML view model using an existing OPC UA metadata model. The UML view model may be subjected to text editing and relationship adjustment by a user. The information model generating subunit 4046 is configured to parse the UML view model into corresponding nodes so as to generate an OPC UA information model.

In one example, the IOT semantic model file defining unit is further configured to convert the IOT semantic model file into a JSON format. In one example, the OPC UA protocol-compliant file includes at least one of an XML file, a bsd file, and a document file. In one example, the specific object includes at least one of a physical device and a virtual entity.

In some embodiments, compared with existing tools, an existing IOT semantic model is used to reduce the complexity of an information model. Then, it is easy to maintain because a semantic model that is friendly to people reading is used. Finally, a mode of exporting an information model at runtime is provided, which means that users may easily upgrade the information model based on system changes. In some embodiments, a semantic model, semantic analysis, and a distributed object technology may be combined for friendly and flexible use.

It should be noted that the structures of the information processing apparatus 400 shown in FIG. 4 and FIG. 5 and constitutional units thereof are merely exemplary. Those skilled in the art may modify structural block diagrams shown in FIG. 4 and FIG. 5 as needed. The details of operations and functions of various parts of the information processing apparatus 400 may be the same as or similar to the relevant parts of the embodiment of the information processing method 100 of the disclosure described with reference to FIGS. 1-3. The descriptions thereof are omitted herein.

As described above with reference to FIGS. 1 to 5, the embodiments of the method and the apparatus for a recommendation data preprocessing algorithm according to an embodiment of the disclosure have been described. The apparatus for a recommendation data preprocessing algorithm described above may be implemented by hardware, or may be implemented by software or a combination of hardware and software.

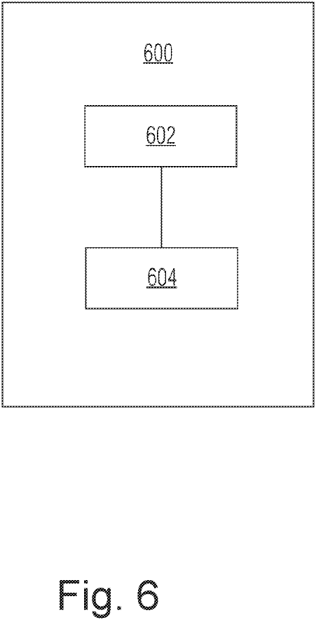

FIG. 6 illustrates a block diagram of a computing device 600 that implements a recommendation data preprocessing algorithm incorporating teachings of the present disclosure. According to one embodiment, the computing device 600 may include at least one processor 602. The at least one processor 602 executes at least one computer-readable instruction (i.e., the above elements implemented in a software form) stored or encoded in a computer-readable storage medium (i.e., memory 604).

In some embodiments, the memory 604 stores computer-executable instructions that, when executed, cause the at least one processor 602 to complete the following actions: defining an IOT semantic model file of a specific object using an existing IOT semantic model; generating an OPC UA information model based on the IOT semantic model file; parsing the OPC UA information model into an OPC UA protocol-compliant file; and generating a source code available for an OPC UA protocol stack using an adapter based on the OPC UA protocol-compliant file. It should be understood that, computer executable instructions stored in the memory 604, when executed, cause at least one processor 602 to perform the various operations and functions described in the foregoing embodiments of the disclosure with reference to FIGS. 1 to 5.

In some embodiments, a non-transient machine readable medium is provided. The non-transient machine readable medium may be provided with machine executable instructions (that is, the foregoing elements implemented in a software form), and the instructions, when executed by a machine, cause the machine to perform the various operations and functions described in the foregoing embodiments of the disclosure with reference to FIGS. 1 to 5.

In some embodiments, a computer program is provided, including computer executable instructions. The computer executable instructions, when executed, cause at least one processor to perform the various operations and functions described in the foregoing embodiments of the disclosure with reference to FIGS. 1 to 5.

In some embodiments, a computer program product is provided, including computer executable instructions. The computer executable instructions, when executed, cause at least one processor to perform the various operations and functions described in the foregoing embodiments of the disclosure with reference to FIGS. 1 to 5.

Exemplary embodiments are described above in combination with specific implementations illustrated in the accompanying drawings, but this does not represent all embodiments that may be implemented or fall within the protection scope of the disclosure. A term “exemplary” used in the entire specification means “used as an example, an instance, or an illustration”, and does not mean “preferred” or “superior” over other embodiments. To provide an understanding of the described technologies, the specific implementations include specific details. However, these technologies may be implemented without these specific details. In some embodiments, to avoid confusing the concept of the described embodiments, a well-known structure and apparatus are shown in a block diagram form.

The descriptions of the content of the disclosure are provided to allow any person of ordinary skill in the art to implement or use the content of the disclosure. For a person of ordinary skill in the art, various modifications on the content of the disclosure are obvious. In addition, a general principle defined in this specification may be applied to other variants without departing from the protection scope of the content of the disclosure. Therefore, the content of the disclosure is not limited to the examples and designs described in this specification, but is consistent with the widest range conforming to the principle and novelty disclosed in this specification.

What is claimed is:

1. An information processing method comprising:
defining an Internet of Things (IOT) semantic model file of a specific object using an existing IOT semantic model;
generating an Open Platform Communication Unified Architecture (OPC UA) information model based on the IOT semantic model file;
parsing the OPC UA information model into an OPC UA protocol-compliant file; and
generating a source code available for an OPC UA protocol stack using an adapter based on the OPC UA protocol-compliant file.

2. The method according to claim 1, wherein generating an OPC UA information model based on the IOT semantic model file comprises:
semantically analyzing the IOT semantic model file to obtain a Unified Modeling Language (UML) file;
converting the UML file into an OPC UA protocol-compliant UML view model using an existing OPC UA metadata model; and
parsing the UML view model into corresponding nodes so as to generate an OPC UA information model.

3. The method according to claim 2, further comprising:
editing the UML view model; and adjusting a relationship adjustment .

4. The method according to claim 1, wherein defining an IOT semantic model file of a specific object using an existing IOT semantic model comprises converting the IOT semantic model file into a JSON format.

5. The method according to claim 1, wherein the OPC UA protocol-compliant file comprises at least one of an Extensible Markup Language (XML) file, a Boundary Scan Description (bsd) file, and a document file.

6. (canceled)

7. An information processing apparatus comprising:
an IOT semantic model file defining unit configured to define an IOT semantic model file of a specific object using an existing IOT semantic model;
an OPC UA information model generating unit configured to generate an OPC UA information model based on the IOT semantic model file;
a parsing unit configured to parse the OPC UA information model into an OPC UA protocol-compliant file; and
a source code generating unit configured to generate a source code available for an OPC UA protocol stack using an adapter based on the OPC UA protocol-compliant file.

8. The apparatus according to claim 7, wherein the OPC UA information model generating unit comprises:
a semantic analysis subunit configured to semantically analyze the IOT semantic model file to obtain a UML file;
a view model generating subunit configured to convert the UML file into an OPC UA protocol-compliant UML view model using an existing OPC UA metadata model; and
an information model generating subunit configured to parse the UML view model into corresponding nodes so as to generate an OPC UA information model.

9. The apparatus according to claim 8, wherein the view model generating subunit is further configured to perform text editing and relationship adjustment by a user.

10. The apparatus according to claim 7, wherein the IOT semantic model file defining unit is further configured to convert the IOT semantic model file into a JSON format.

11. The apparatus according to claim 7, wherein the OPC UA protocol-compliant file comprises at least one of an XML file, a bsd file, and a document file.

12. (canceled)

13. A computing device comprising:
a processor; and
a memory coupled to the processor, the memory storing instructions that, when executed by the processor, cause the processor to:
defining an Internet of Things (IOT) semantic model file of a specific object using an existing IOT semantic model;
generating an Open Platform Communication Unified Architecture (OPC UA) information model based on the IOT semantic model file;
parsing the OPC UA information model into an OPC UA protocol-compliant file; and
generating a source code available for an OPC UA protocol stack using an adapter based on the OPC UA protocol-compliant file.

14-16. (canceled)
